(19) United States
(12) Patent Application Publication
(10) Pub. No.: US 2016/0040790 A1
(43) Pub. Date: Feb. 11, 2016

(54) SAFETY MECHANISM FOR A DIRECTIONAL CONTROL VALVE EQUPPED WITH PNEUMATIC FLUID-RECYCLING DELAY FUNCTION

(71) Applicant: AEROVALVE LLC, St. Louis, MO (US)

(72) Inventors: Ellen R. Mell, St. Louis, MO (US); Dennis T. Mell, St. Louis, MO (US)

(21) Appl. No.: 14/776,572

(22) PCT Filed: Mar. 14, 2014
(86) PCT No.: PCT/US2014/027274

§ 371 Date: Sep. 14, 2015

Related U.S. Application Data
(60) Provisional application No. 61/783,164, filed on Mar. 14, 2013.

(51) Int. Cl. F16K 11/07; F16K 31/02

(52) U.S. Cl. CPC F16K 11/07; F16K 31/02

(57) ABSTRACT

The present invention describes a safety mechanism for a directional control valve. The mechanism can be implemented into various valve configurations which are commonly found in the directional control valve industry, including but not limited to those configurations which are adapted to contain a pneumatic fluid-recycling delay function.

### CROSS-REFERENCE TO RELATED APPLICATIONS

This application claims priority to U.S. Provisional Patent Application Ser. No. 61/783,164, filed Mar. 14, 2013, the contents of which are incorporated herein by reference.

### FIELD

The present disclosure relates generally to the field of directional control valves, and more specifically to the field of pneumatic directional control valves with a fluid-recycling delay function.

### BACKGROUND

This section provides background information related to the present disclosure which is not necessarily prior art.

Directional control valves are well established in modern industry, and are used to regulate and control the flow of fluids through a system. Directional control valves designed for use in pneumatic applications, frequently termed ‘pneumatic valves’, are utilized to regulate the flow of gaseous fluids. Frequently, these pneumatic valves are utilized to provide a means to transfer mechanical energy, via the delivery of high-pressure gaseous fluids, to a mechanical device, or actuator. By changing the path of fluid flow through a typical pneumatic valve, an actuator in fluid communication with the pneumatic valve, and positioned downstream from the valve, can be made to move from one position to another.

Specifically, in typical pneumatic valve application, the pneumatic valve will frequently have two output ports, A and B. By connecting output port A to one side of an actuator, e.g. an air cylinder, and by connecting output port B to an opposing side of the same actuator, the actuator can be made to move back and forth between two positions by simply changing the path of high-pressure gaseous fluid, e.g. compressed air, through the valve. If high-pressure air flows through port A, then the side of the actuator attached to port A will receive a positive mechanical force, causing the actuator to move away from the force being applied. If high-pressure air flows instead through port B, then the side of the actuator attached to port B will receive a positive mechanical force, causing the actuator to again move away from the force being applied.

Traditionally, pneumatic valves have been considered highly inefficient, due in large part because each time the pneumatic valve changes position and alters the direction of fluid flow, the high-pressure gaseous fluid located downstream (between the pneumatic valve an the actuator) is vented away through an exhaust port and lost. For example, if the pneumatic valve is in a first position such that high-pressure gaseous fluid is present within the downstream channel in fluid communication with output port A, then when the pneumatic valve moves to a second position such that high-pressure gaseous fluid now flows freely through output port B, then the valve's internal porting mechanism contemporaneously establishes a path of fluid communication between output port A and an exhaust port. This path of fluid communication between output port A and the exhaust port effectively provides a venting mechanism, which allows the high-pressure gaseous fluid to escape and be lost. This venting process repeats itself each time the pneumatic valve changes position.

Recent technical developments, including those disclosed in U.S. Pat. No. 8,635,940, have established a means for incorporating a pneumatic fluid-recycling function within a standard three-position pneumatic valve such that a portion of the high-pressure gaseous fluid is ‘recycled’ during the valve's switching process. This recycling mechanism is embodied by incorporating a delay function during the valve's switching process, such that the valve pauses in a third position, located between the traditional first position and the traditional second position. During this delay period, or ‘dwell’, the valve's internal porting configuration allows the two output ports A and B of the valve to establish an exclusive fluid communication between themselves, while being isolated from any other ports of the valve. During this dwell period, the gaseous fluid is allowed to equilibrate between the two ports, and therefore also between the two sides of a typical two-sided actuator located downstream from the valve, and with each of the two sides in fluid communication with one of the two output ports A and B. Using this dwell mechanism, a significant amount of high-pressure gaseous fluid, e.g. high pressure air, can be recycled, rather than being vented away.

While the recycling methodology described above provides a significant energy savings opportunity, the recycling methodology developed prior to the current disclosure disables certain desirable safety functions of the valve. Specifically, current industry standards for three-position pneumatic directional control valves define three industry-standard safety behaviors for the valves during a power-loss event. These standard safety behaviors are commonly referred to as ‘exhaust’ center, ‘pressure’ center, and ‘closed’ center. All three safety behaviors are readily available in modern commercial markets.

The disclosure presented herein describes a novel approach for incorporating a safety mechanism within a three-position pneumatic valve that is equipped with a fluid recycling function, such that the valve may maintain any one of the desired industry-standard safety behaviors, while also achieving the advantages of a recycling methodology.

### SUMMARY

This section provides a general summary of the disclosure, and is not a comprehensive disclosure of its full scope or all of its features.

The application herein describes a valve system with a safety mechanism for use in a three-position pneumatic directional control valve that is equipped with an air-recycling function. The disclosure comprises a directional control valve having a valve body section that has at least two output ports, namely a first output port ‘A’ and a second output port ‘B’, at least one exhaust port, and at least one supply, or ‘pressure’ port. The directional control valve additionally includes a spool mechanism located within the valve body section, such that the spool mechanism is capable of maintaining a first and a second location position within the valve body section. The directional control valve additionally includes a control system, preferably electronic, that is capable of controlling the movement of the spool mechanism between the first and second positions. The directional control valve additionally includes a system for implementing a delay in the transit of the spool mechanism at a third position located between the first and second location positions such that when the spool mechanism is located in the third position and the valve is supplied with a positive electrical signal, the first output port A and the second output port B are in exclusive fluid communication via a fluid channel, designated the ‘A-B channel’, within the valve body section. During the interval when the spool mechanism is in the third position such that the first output port A and the second output port B are in exclusive fluid communication, pneumatic fluid may be recycled between the two output ports of the directional control valve, thus providing an energy-saving result.

The exclusive fluid communication that occurs between the first output port A and the second output port B when the spool mechanism resides in the third position allows pneumatic fluid to be recycled between the two output ports when the valve is in normal operation, namely when the valve is receiving a positive electrical signal. In the present disclosure, the directional control valve also includes a safety mechanism such that when the valve is not supplied with a positive electrical signal, or after some proscribed interval of time after a positive electrical signal is no longer supplied, the spool mechanism remains in the third position but the first output port A and the second output port B are no longer in exclusive fluid communication.

The modern directional control valve industry has established three standard behaviors for the third position (center position) behavior of three-position directional control valves when a power loss occurs. The first standard behavior during a power loss is often termed an ‘exhaust’ center position behavior, wherein when the directional control valve is not supplied with a positive electrical signal, or after some proscribed interval of time after a positive electrical signal is no longer supplied, the first output port A and the second output port B are in fluid communication with each other and are also in fluid communication with an exhaust port. Thus, a preferred result of this ‘exhaust’ behavior is that when the valve loses power, any potential energy stored inside the valve's output ports is vented out of the valve via the exhaust port.

A second standard behavior for a directional control valve when a power loss occurs is often termed a ‘pressure’ center position behavior, wherein when the valve is not supplied with a positive electrical signal, or after some proscribed interval of time after a positive electrical signal is no longer supplied, the first output port A and the second output port B are in fluid communication with each other and are also in fluid communication with a pressure port. Thus, a preferred result of this ‘pressure’ behavior is that when the valve loses power, both output ports of the valve equilibrate at a pressure equivalent to the pressure of the fluid residing within the incoming pressure port of the valve.

A third standard behavior for a directional control valve when a power loss occurs is often termed a ‘closed’ center position behavior, wherein when the valve is not supplied with a positive electrical signal, or after some proscribed interval of time after a positive electrical signal is no longer supplied, the first output port A and the second output port B are each separately pneumatically isolated and each separately not in fluid communication with any other port of the directional control valve. Thus, a preferred result of this ‘closed’ behavior is that when the valve loses power, each of the output ports individually retain the pressure that was present in each of the output ports prior to the power loss.

In all three of these standard power loss behaviors, a preferred embodiment of the present disclosure includes an automatic safety mechanism that allows a chosen standard power-loss safety behavior to occur with no direct intervention required. In a preferred embodiment, the automatic safety mechanism is comprised of a simple two-way valve, designated as the ‘safety device’ of the valve system, with the safety device having the capability of maintaining a first position and a second position such that when the safety device receives a positive electrical signal (such as would occur during normal valve operation), the safety device resides in the first position and when the safety device does not receive a positive electrical signal (such as would occur during a power loss), the safety device ‘activates’ and moves to reside in the second position. In a preferred embodiment, the safety device is controlled via electronic signals provided by an electronic control mechanism.

In another preferred embodiment applicable to all three of the standard power loss behaviors, the electronic control mechanism that controls the safety device contains a means for electrical power storage such that the electronic control mechanism can continue to deliver a positive electrical signal to the safety device for a proscribed interval of time after a positive electrical signal is not delivered to the electronic control mechanism. By this means, a preferred result is that activation of the safety device can be delayed for a proscribed period of time after a positive electrical signal is not delivered to the electronic control mechanism.

In a preferred embodiment of the ‘exhaust’ center position behavior option, the safety device is positioned within a fluid channel, designated the ‘safety channel’ of the valve system, such that the safety device is capable of blocking fluid flow through the safety channel when it resides in the first position and is capable of allowing fluid flow through the safety channel when it resides in the second position; and wherein the safety channel is at one end adjoined to and in fluid communication with the A-B channel of the main valve and at the other end is adjoined to and in fluid communication with an exhaust port of the main valve. In an exemplary embodiment, the safety device is a ‘normally-open’ direct-acting two-way solenoid valve, such that when the safety device receives a positive electrical signal, it resides in a first position that blocks fluid flow through the safety device and when the safety device does not receive a positive electrical signal, it resides in a second position that allows fluid flow through the safety device.

In a preferred embodiment of the ‘pressure’ center position behavior option, the safety device is positioned within a fluid channel, designated the ‘safety channel’ of the valve system, such that the safety device is capable of blocking fluid flow through the safety channel when it resides in the first position and is capable of allowing fluid flow through the safety channel when it resides in the second position; and wherein the safety channel is at one end adjoined to and in fluid communication with the A-B channel of the main valve and at the other end is adjoined to and in fluid communication with a pressure port of the main valve. In a an exemplary embodiment, the safety device is a ‘normally-open’ direct-acting two-way solenoid valve, such that when the safety device receives a positive electrical signal, it resides in a first position that blocks fluid flow through the safety device and when the safety device does not receive a positive electrical signal, it resides in a second position that allows fluid flow through the safety device.

In a preferred embodiment of the ‘closed’ center position behavior option, the safety device is positioned within the A-B channel of the main valve such that the safety device is capable of allowing fluid flow through the A-B channel when the safety device resides in its first position and such that the safety device is capable of blocking fluid flow through the A-B channel of the main valve when the safety device resides in its second position. In an exemplary embodiment, the safety device is a ‘normally-closed’ direct-acting two-way solenoid valve, such that when the safety device receives a positive electrical signal, it resides in a first position that allows fluid flow through the safety device and when the safety devices does not receive a positive electrical signal, it resides in a second position that blocks fluid flow through the safety device.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

In the drawings:

FIG. 1 illustrates a section view of an exemplary embodiment of the main valve body and spool assembly of a three-position directional control valve with a fluid-recycling mechanism in a first position.

FIG. 2 illustrates a section view of an exemplary embodiment of the main valve body and spool assembly of a three-position directional control valve with a fluid-recycling mechanism in a second position.

FIG. 3 illustrates a section view of an exemplary embodiment of the main valve body and spool assembly of a three-position directional control valve with a fluid-recycling mechanism in a third and central position.

FIG. 4 illustrates a pneumatic schematic of an exemplary embodiment of the invention having an ‘exhaust’ center position safety behavior.

FIG. 5 illustrates a pneumatic schematic of an exemplary embodiment of the invention having a ‘pressure’ center position safety behavior.

FIG. 6 illustrates a pneumatic schematic of an exemplary embodiment of the invention having a ‘closed’ center position safety behavior.

### DETAILED DESCRIPTION

Example embodiments will now be described more fully with reference to the accompanying drawings.

The accompanying drawings illustrate a safety mechanism for a directional control valve equipped with a pneumatic fluid-recycling delay function.

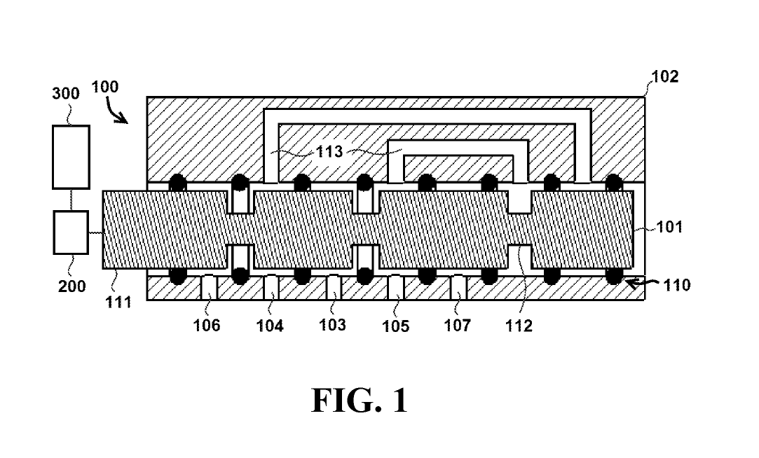

Referring now to FIGS. 1-3, an exemplary embodiment of this disclosure comprises a directional control valve 100 comprising a directional control valve body section 102 with at least two output ports, namely at least a first output port 104 and a second output port 105, at least one pressure port 103, an exhaust port 106 and an additional exhaust port 107; and a spool mechanism 101 located within the valve body section 102, with said spool mechanism 101 capable of maintaining three location positions within the valve body section 102.

Referring now specifically to FIG. 1, the drawing illustrates the spool mechanism 101 in a first location position within the valve body section 102.

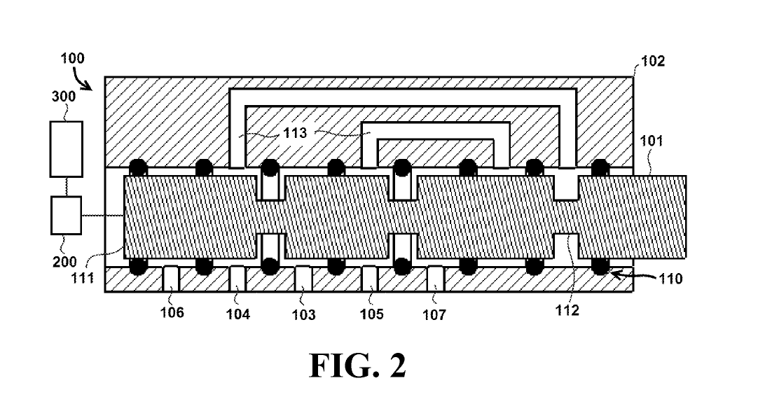

Referring now specifically to FIG. 2, the drawing illustrates the spool mechanism 101 in a second location position within the valve body section 102.

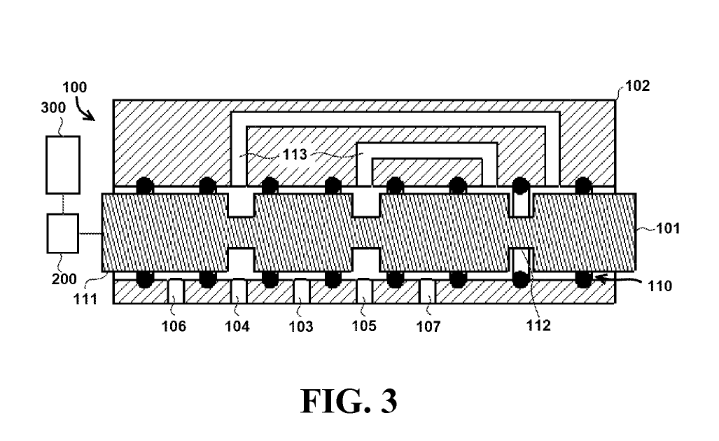

Referring now specifically to FIG. 3, the drawing illustrates the spool mechanism 101 in a third position located between the first and second location positions such that when the spool mechanism resides in the third position, the first output port 104 and the second output port 105 are in exclusive fluid communication via a fluid channel 113, termed the ‘A-B channel’, within the valve body section 102. In certain embodiments, A-B channel 113 may comprise more than one channel segment, including for example, the configuration shown in FIGS. 1-3.

Referring again to FIGS. 1-3, the drawings illustrate a control system 200 for controlling movement of the spool mechanism 101 such that the spool mechanism 101 can move between a first position as depicted in FIG. 1 and a second position as depicted in FIG. 2, and an electronic control mechanism 300 for implementing a delay in the transit of the spool mechanism 101. In certain preferred embodiments, the spool mechanism 101 comprises a series of outer lobes 111, a series of grooves 112 located between the series of outer lobes 111, and a series of sealing mechanisms 110 securably affixed between the valve body section 102 and the spool mechanism 101.

Referring now to FIGS. 3-6, an exemplary embodiment of this disclosure comprises a safety mechanism 400 configured such that when the directional control valve 100 is not supplied with a positive electrical signal, or after some proscribed interval of time after a positive electrical signal is no longer supplied, the spool mechanism 101 remains in the third position as depicted in FIG. 3, but the first output port 104 and the second output port 105 are not in exclusive fluid communication.

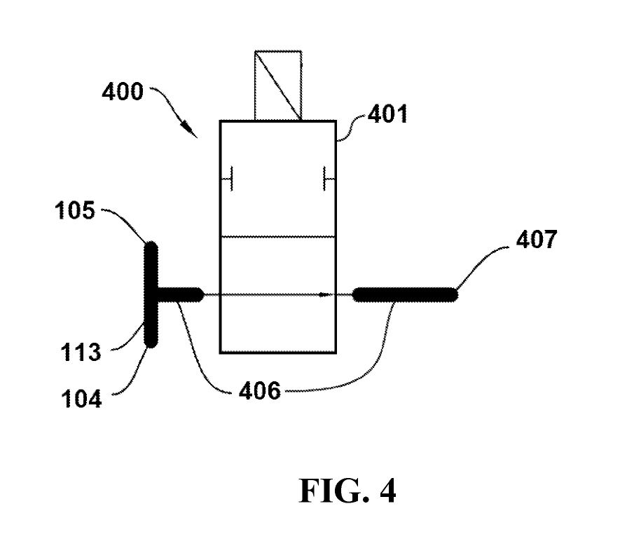

Referring now specifically to FIG. 3 and FIG. 4, an exemplary embodiment of this disclosure comprises a safety mechanism 400 configured such when the directional control valve 100 is not supplied with a positive electrical signal, or after some proscribed interval of time after a positive electrical signal is no longer supplied, the first output port 104 and the second output port 105 are in fluid communication with each other and are also in fluid communication with an exhaust port 407. In certain embodiments, exhaust port 407 is in fluid communication with exhaust port 106. In other embodiments, exhaust port 407 is in fluid communication with exhaust port 107. In yet other embodiments, exhaust port 407 is separate and distinct from both exhaust port 106 and exhaust port 107.

Referring now specifically to FIG. 4, certain exemplary embodiments comprise an automatic safety mechanism 400 to automatically effect the fluid communication between the first output port 104 and the second output port 105 and the exhaust port 407 when the directional control valve 100 is not supplied with a positive electrical signal, or after some proscribed interval of time after a positive electrical signal is no longer supplied.

Referring again to FIG. 3 and FIG. 4, certain exemplary embodiments of the automatic safety mechanism 400 comprise a two-way valve 401, designated as the ‘safety device’ of the valve system, with the safety device 401 having the capability of maintaining a first position and a second position such that when the safety device 401 receives a positive electrical signal, it resides in the first position and when the safety device does not receive a positive electrical signal it resides in the second position. Certain exemplary embodiments incorporate use of an electronic control mechanism 300 capable of controlling movement of the safety device 401 via electronic signals.

Referring again to FIG. 3 and FIG. 4, in certain exemplary embodiments the safety device 401 is a two-position normally-open pneumatic solenoid valve and is positioned within a fluid channel 406, designated the ‘safety channel’ of the valve system, such that the safety device 401 is capable of blocking fluid flow through the safety channel 406 when the safety device 401 resides in the first position and is capable of allowing fluid flow through the safety channel 406 when the safety device 401 resides in the second position. In certain exemplary embodiments, the safety channel 406 is at one end adjoined to and in fluid communication with the A-B channel 113 and at the other end is adjoined to and in fluid communication with exhaust port 407, which may in certain embodiments be in fluid communication with exhaust port 106 or exhaust port 107. In certain exemplary embodiments, the electronic control mechanism 300 contains a means for electrical power storage such that the electronic control mechanism 300 can continue to deliver a positive electrical signal to the safety device 401 for a proscribed interval of time after a positive electrical signal is not delivered to the electronic control mechanism 300.

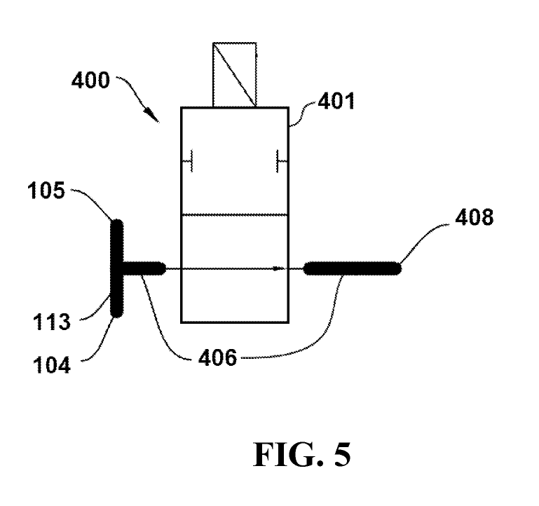

Referring now specifically to FIG. 3 and FIG. 5, another exemplary embodiment of this disclosure comprises a safety mechanism 400 configured such when the directional control valve 100 is not supplied with a positive electrical signal, or after some proscribed interval of time after a positive electrical signal is no longer supplied, the first output port 104 and the second output port 105 are in fluid communication with each other and are also in fluid communication with a pressure port 408. In certain embodiments, pressure port 408 is in fluid communication with pressure port 103. In other embodiments, pressure port 408 is separate and distinct from pressure port 103.

Referring now specifically to FIG. 5, certain exemplary embodiments comprise an automatic safety mechanism 400 to automatically effect the fluid communication between the first output port 104 and the second output port 105 and the pressure port 408 when the directional control valve 100 is not supplied with a positive electrical signal, or after some proscribed interval of time after a positive electrical signal is no longer supplied.

Referring again to FIG. 3 and FIG. 5, certain exemplary embodiments of the automatic safety mechanism 400 comprise a two-way valve 401, designated as the ‘safety device’ of the valve system, with the safety device 401 having the capability of maintaining a first position and a second position such that when the safety device 401 receives a positive electrical signal, it resides in the first position and when the safety device 401 does not receive a positive electrical signal it resides in the second position. Certain exemplary embodiments incorporate use of an electronic control mechanism 300 capable of controlling movement of the safety device 401 via electronic signals.

Referring again to FIG. 3 and FIG. 5, in certain exemplary embodiments the safety device 401 is a two-position normally-open pneumatic solenoid valve and is positioned within a fluid channel 406, designated the ‘safety channel’ of the valve system, such that the safety device 401 is capable of blocking fluid flow through the safety channel 406 when the safety device 401 resides in the first position and is capable of allowing fluid flow through the safety channel 406 when the safety device 401 resides in the second position. In certain exemplary embodiments, the safety channel 406 is at one end adjoined to and in fluid communication with the A-B channel 113 and at the other end is adjoined to and in fluid communication with pressure port 408, which may in certain embodiments be in fluid communication with pressure port 103. In certain exemplary embodiments, the electronic control mechanism 300 contains a means for electrical power storage such that the electronic control mechanism 300 can continue to deliver a positive electrical signal to the safety device 401 for a proscribed interval of time after a positive electrical signal is not delivered to the electronic control mechanism 300.

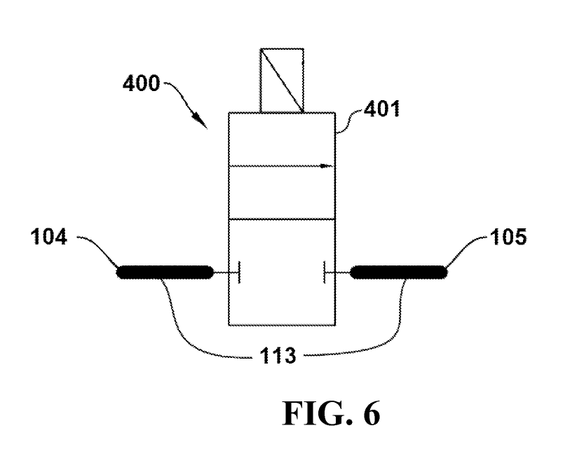

Referring now specifically to FIG. 3 and FIG. 6, another exemplary embodiment of this disclosure comprises a safety mechanism 400 configured such that when the directional control valve 100 is not supplied with a positive signal, or after some proscribed interval of time after a positive electrical signal is no longer supplied, the first output port 104 and the second output port 105 are each separately pneumatically isolated and each separately not in fluid communication with any other port of the directional control valve 100.

Referring now specifically to FIG. 6, certain exemplary embodiments comprise an automatic safety mechanism 400 to automatically effect the individual pneumatic isolation of both the first output port 104 and the second output port 105 when the directional control valve 100 is not supplied with a positive electrical signal, or after some proscribed interval of time after a positive electrical signal is no longer supplied.

Referring again to FIG. 3 and FIG. 6, certain exemplary embodiments of the automatic safety mechanism 400 comprise a two-way valve 401, designated as the ‘safety device’ of the valve system, with the safety device 401 having the capability to maintain a first position and a second position such that when the safety device 401 receives a positive electrical signal, it resides in the first position and when the safety device 401 does not receive a positive electrical signal it resides in the second position. Certain exemplary embodiments incorporate use of an electronic control mechanism 300 capable of controlling movement of the safety device 401 via electronic signals.

Referring again to FIG. 3 and FIG. 6, in certain exemplary embodiments the safety device 401 is a two-position normally-closed pneumatic solenoid valve and is positioned within the A-B channel 113 of the main valve such that the safety device is capable of allowing fluid flow through the A-B channel 113 when the safety device resides in its first position and such that the safety device 401 is capable of blocking fluid flow through the A-B channel when the safety device 401 resides in its second position. In certain exemplary embodiments, the electronic control mechanism 300 contains a means for electrical power storage such that the electronic control mechanism 300 can continue to deliver a positive electrical signal to the safety device 401 for a proscribed interval of time after a positive electrical signal is not delivered to the electronic control mechanism 300.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

### REFERENCES

The following references, to the extent that they provide exemplary procedural or other details supplementary to those set forth herein, are specifically incorporated herein by reference.
U.S. Pat. No. 8,635,940

What is claimed:

1. A directional control valve comprising: a directional control valve body section with at least two output ports, namely at least a first output port ‘A’ and a second output port ‘B’, at least one pressure port, and at least one exhaust port; a spool mechanism located within the valve body section capable of maintaining a first and a second location position within the valve body section; a control system for controlling movement of the valve between the first position and the second position; an electronic control mechanism for implementing a delay in the transit of the spool mechanism at a third position located between the first and second location positions such that when the spool mechanism is located in the third position and the valve is supplied with a positive electrical signal, the first output port A and the second output port B are in exclusive fluid communication via a fluid channel, designated the ‘A-B channel’, within the valve body section.

2. The directional control valve of claim 1, comprising a safety mechanism such that when the valve is not supplied with a positive electrical signal, or after some proscribed interval of time after a positive electrical signal is no longer supplied, the spool mechanism remains in the third position but the first output port A and the second output port B are not in exclusive fluid communication.

3. The directional control valve of claim 2, wherein when the valve is not supplied with a positive electrical signal, or after some proscribed interval of time after a positive electrical signal is no longer supplied, the first output port A and the second output port B are in fluid communication with each other and are also in fluid communication with an exhaust port.

4. The directional control valve of claim 2, wherein when the valve is not supplied with a positive electrical signal, or after some proscribed interval of time after a positive electrical signal is no longer supplied, the first output port A and the second output port B are in fluid communication with each other and are also in fluid communication with a pressure port.

5. The directional control valve of claim 2, wherein when the valve is not supplied with a positive electrical signal, or after some proscribed interval of time after a positive electrical signal is no longer supplied, the first output port A and the second output port B are each separately pneumatically isolated and each separately not in fluid communication with any other port of the directional control valve.

6. The directional control valve of claim 3, wherein the directional control valve comprises an automatic safety mechanism to automatically effect the fluid communication between the first output port A and the second output port B and the exhaust port when the directional control valve is not supplied with a positive electrical signal, or after some proscribed interval of time after a positive electrical signal is no longer supplied.

7. The directional control valve of claim 4, wherein the directional control valve comprises an automatic safety mechanism to automatically effect the fluid communication between the first output port A and the second output port B and the pressure port when the directional control valve is not supplied with a positive electrical signal, or after some proscribed interval of time after a positive electrical signal is no longer supplied.

8. The directional control valve of claim 5, wherein the directional control valve comprises an automatic safety mechanism to automatically effect the individual pneumatic isolation of both the first output port A and the second output port B when the directional control valve is not supplied with a positive electrical signal, or after some proscribed interval of time after a positive electrical signal is no longer supplied.

9. A valve system comprising:
the directional control valve of claim 6, wherein the directional control valve is designated as the ‘main valve’ of the valve system, and the automatic safety mechanism comprises:
a two-way valve, designated as the ‘safety device’ of the valve system, with the safety device having the capability of maintaining a first position and a second position such that when the safety device receives a positive electrical signal, it resides in the first position and when the safety device does not receive a positive electrical signal it resides in the second position; and an electronic control mechanism capable of controlling movement of the safety device via electronic signals.

10. The valve system of claim 9, wherein the safety device is positioned within a fluid channel, designated the ‘safety channel’ of the valve system, such that the safety device is capable of blocking fluid flow through the safety channel when it resides in the first position and is capable of allowing fluid flow through the safety channel when it resides in the second position; and wherein the safety channel is at one end adjoined to and in fluid communication with the A-B channel of the main valve and at the other end is adjoined to and in fluid communication with an exhaust port of the main valve.

11. The valve safety mechanism of claim 10, wherein the electronic control mechanism contains a means for electrical power storage such that the electronic control mechanism can continue to deliver a positive electrical signal to the safety device for a proscribed interval of time after a positive electrical signal is not delivered to the electronic control mechanism.

12. A valve system comprising:
the directional control valve of claim 7, wherein the directional control valve is designated as the ‘main valve’ of the valve system, and the automatic safety mechanism comprises:
a two-way valve, designated as the ‘safety device’ of the valve system, with the safety device having the capability of maintaining a first position and a second position such that when the safety device receives a positive electrical signal, it resides in the first position and when the safety device does not receive a positive electrical signal it resides in the second position; and an electronic control mechanism capable of controlling movement of the safety device via electronic signals.

13. The valve system of claim 12, wherein the safety device is positioned within a fluid channel, designated the ‘safety channel’ of the valve system, such that the safety device is capable of blocking fluid flow through the safety channel when it resides in the first position and is capable of allowing fluid flow through the safety channel when it resides in the second position; and wherein the safety channel is at one end adjoined to and in fluid communication with the A-B channel of the main valve and at the other end is adjoined to and in fluid communication with a pressure port of the main valve.

14. The valve safety mechanism of claim 13, wherein the electronic control mechanism contains a means for electrical power storage such that the electronic control mechanism can continue to deliver a positive electrical signal to the safety device for a proscribed interval of time after a positive electrical signal is not delivered to the electronic control mechanism.

15. A valve system comprising:
the directional control valve of claim 8, wherein the directional control valve is designated as the ‘main valve’ of the valve system, and the automatic safety mechanism comprises:
a two-way valve, designated as the ‘safety device’ of the valve system, with the safety device having the capability of maintaining a first position and a second position such that when the safety device receives a positive electrical signal, it resides in the first position and when the safety device does not receive a positive electrical signal it resides in the second position; and an electronic control mechanism capable of controlling movement of the safety device via electronic signals.

16. The valve system of claim 15, wherein the safety device is positioned within the A-B channel of the main valve such that the safety device is capable of allowing fluid flow through the A-B channel when the safety device resides in its first position and such that the safety device is capable of blocking fluid flow through the A-B channel of the main valve when the safety device resides in its second position.

17. The valve safety mechanism of claim 16, wherein the electronic control mechanism contains a means for electrical power storage such that the electronic control mechanism can continue to deliver a positive electrical signal to the safety device for a proscribed interval of time after a positive electrical signal is not delivered to the electronic control mechanism.
